(19) United States
(12) Patent Application Publication
(10) Pub. No.: US 2013/0151321 A1
(43) Pub. Date: Jun. 13, 2013

(54) CUSTOMER INCENTIVE REWARD CARD MATCHING METHOD

(71) Applicants: Leonardo Roman, Miami, FL (US); Jorge Vilarino, Miami, FL (US)

(72) Inventors: Leonardo Roman, Miami, FL (US); Jorge Vilarino, Miami, FL (US)

(21) Appl. No.: 13/314,763

(22) Filed: Dec. 8, 2011

(51) Int. Cl. G06Q 30/02

(52) U.S. Cl. 705/14.15

(57) ABSTRACT

A customer incentive reward card matching method that allows a merchant or affiliation of merchants to create incentive, retention,, and marketing methods for a customer by providing the customer with a reward card that has a matching value to the customer's initial purchase price. The reward card is designed to incentivize the customer to return to the merchant for future business and also generate profits for the merchant by charging premium prices for products and services, requiring minimum price purchases, charging a small administrative fee, and other prerequisites. The customer incentive reward card matching method further utilizes a point of sale device connected to a remote computer to download, view, analyze, edit, and process customer transaction history data.

### BACKGROUND

The present invention is a customer incentive reward card matching method that is used to encourage customer loyalty to a merchant by providing the customer with a reward card that has a value matching the customer's initial purchase, while monitoring all of the reward card transactions from a computerized point of sale.

The inventors of the present invention are merchants. They utilize advertising, marketing, reward cards, points systems, customer loyalty reward incentives, and other well known methods to encourage their customers to repetitively purchase products and services from them. During their years of performing customer loyalty transactions with their customers, they identified a problem with their customer retention rate and their general lack of knowledge about the customers' transaction habits.

The inventors recognized that the chief problem with retaining customer loyalty was that the methods and incentives used with most reward cards and incentive programs provided too little financial benefits. It was easier and more beneficial for the customers to wait for a sale or clip coupons than to return to the initial merchant to cash in a traditional reward card. Another problem was that most reward cards required the customers to perform many steps, or wait for extended periods of time to accumulate points before they could receive the benefits. Most customers did not want to go through this kind of hassle. The inventors recognized that the value of their incentives would have to be dramatically increased and made more customer friendly in order to retain their customers' loyalty and interest.

The above findings caused the inventors first to develop a customer loyalty method that provided the customers with a reward card that had a value that matched the customers' initial purchase price. This new reward card would create an incentive for the customers to return for future transactions with the inventor. The customers would have a sense that they would be receiving a bargain for their dollar, and the inventors would theoretically increase their repeat customers.

However, the inventors realized that their method could not be a profitable endeavor unless they created additional forms of revenue around their proposed reward card. They believe that if they initially raise their retail prices to a premium, so that the difference between their wholesale purchase price and retail sales price is greater than before, that this may be a manner of facilitating their profitable endeavor. This would result in higher initial prices for the customers, yet they believe that the matching reward card benefit should overcome most customers' objections to the new higher prices, for the customer eventually would be obtaining a greater benefit for their dollar, so long as the customers are loyal to the inventor's reward retail establishment.

The inventors further recognize that they need to generate even more profits from their new customer loyalty method. So they recognize that a small administrative fee has to be added to the initial customer purchase price. They calculate that ten percent of the initial purchase price fee could be deducted from the initial value of the reward card that given to customers. This would be a minimal administrative charge that would not raise the customer's initial purchase price to an obscene amount that would scare customers, and would allow them to increase revenues to allow them to compete in the market. The inventors recognize that the incentive for the customers would be kept intact even with the addition of the small administrative fee.

The inventors have performed informal market research and customer polling to gauge what they believe would be customers' reaction to the additional prerequisites for the reward card. They believe that customers should remain loyal, chiefly because of the relatively large value of the reward card. In a further embodiment of the invention, the inventors propose adding some additional requirements prior to allowing customers to obtain the reward card. They may require that some customers make a minimum twenty five dollar initial purchase. This simple step may increase their volume of sales to customers who would be anxious to obtain a reward card. The inventors propose a laundry list of additional requirements to protect them from any losses or liability. These include: that the reward card is valid toward transactions only with the inventor, that the reward card has no warranties, that the reward card is not a credit or debit card, that the reward card is not redeemable for cash unless required by law, that resale of the reward card is not prohibited, that the reward card currency value is not be applied to any credit or loan balance, and that the inventors would not replace lost, stolen, or damaged reward cards. These requirements should be generally accepted as being fair by customers.

Despite all of these steps, the inventors theorized that they would still have difficulty keeping track of their customers' transaction habits and the amount of customers that were utilizing the reward cards. This led the inventors to develop a point of sale device that communicated with a computer program with instructions transferred from a remote server. The instructions allowed the point of sale device to generate a list of customer transaction history data based on the customers' initial purchases, number of visits, reward card value, reward card usage, seasonal purchases, and other customer transaction habits that the inventors considered pertinent. After setting up the point of sale device, the inventors could analyze their customers' transaction history data to create additional customer incentives. The inventors would be able to view and manipulate all of the customers' transaction history data on the point of sale device. Additionally, the inventors designed the computer program to allow the customers to view their reward card currency value balance on the internet from their computer or from their mobile communication device.

Customer loyalty reward card methods have been used in business in the past, yet none with the present characteristics of the present invention. See U.S. Pat. Nos.: 8,007,456; 2011/0238471; 2006/0161478; and 2002/0174011.

For the foregoing reasons, there is a need for a customer incentive reward card matching method that creates customer loyalty and allows a merchant to generate profits and track customer transaction history data.

### SUMMARY

The present invention is directed to a customer incentive reward card matching method that allows a merchant or affiliation of merchants to create incentive, retention, and marketing methods for a customer by providing the customer with a reward card that has a matching value to the customer's initial purchase price. The reward card is designed to incentivize the customer to return to the merchant for future business and also generate profits for the merchant by charging premium prices for products and services, requiring minimum price purchases, charging a small administrative fee, and other prerequisites. The customer incentive reward card matching method further utilizes a point of sale device connected to a remote computer to download, view, analyze, edit, and process customer transaction history data.

The merchant obtains products and services at a wholesale price. The merchant then offers the products and services at a premium price, often significantly more than competitors. The customer qualifies for the reward card after making a minimal requirement purchase of the products and services. The reward card has a reward card currency value that is equal to the customer's initial purchase price, minus an administrative fee, which is ten percent of the customer's initial purchase price. The reward card is designed to encourage the customer to return to the same merchant to purchase products and services; and possibly make additional purchases that exceed the value of the reward card. Furthermore, the merchant can require a twenty five dollar minimum purchase as a prerequisite to providing the reward card to the customer. This incentivizes the customer to make larger initial purchases. In addition to the administrative fee and the minimum purchase price requirement, the merchant generates additional profits by charging a premium price for the products and services. The customer can use the reward card at any future time to purchase additional products and services from the same merchant, subject to one or more restrictions set by the merchant. The merchant can keep track of the customers and their reward card transactions by utilizing a point of sale device.

The point of sale device has a computer program with instructions transferred from a remote computer, such as a server. The instructions allow the point of sale device to generate customer transaction history data based on initial purchases, number of visits, reward card value, reward card usage, seasonal purchases, and other pertinent transaction habits. The merchant can then analyze the customer transaction history data to create additional customer incentives. The merchant is able to view and manipulate all of the customer transaction history data on the point of sale device. Additionally, the merchant can allow the customer to view a predetermined amount of the customer transaction history data on a network such as the internet.

An object of the present invention is to provide an incentive for the customer to repeat business with the merchant.

Another object of the present invention is to create additional profits for the merchant by charging a premium for the products and services, charging an administrative fee, and requiring a minimum purchase as a prerequisite to participate in the customer incentive reward card matching method.

Yet another object of the present invention is to provide customer transaction history data on a customer so that a merchant can review and analyze the data to create additional customer incentives.

Yet another object of the present invention is to encourage the customer to purchase products and services in larger volume.

Yet another object of the present invention is to allow an affiliation of merchants to share a common reward card.

### DRAWINGS

These and other features, aspects, and advantages of the present invention will become better understood with regard to the following description, appended claims, and drawings where:

FIG. 1 is a block diagram illustrating the basic components of the present invention;

FIG. 2 is a simplified schematic diagram illustrating operations of the present invention; and

FIG. 3 is a block diagram illustrating an example, according to one embodiment of the present invention.

### DESCRIPTION

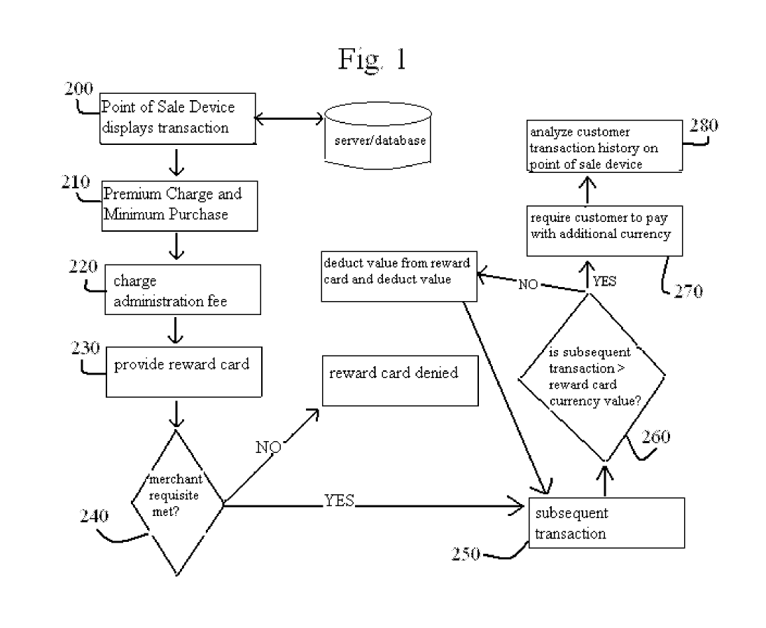

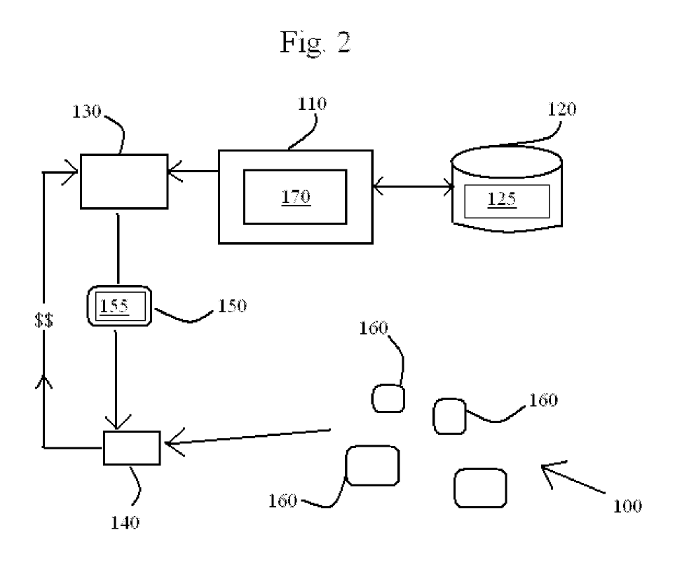

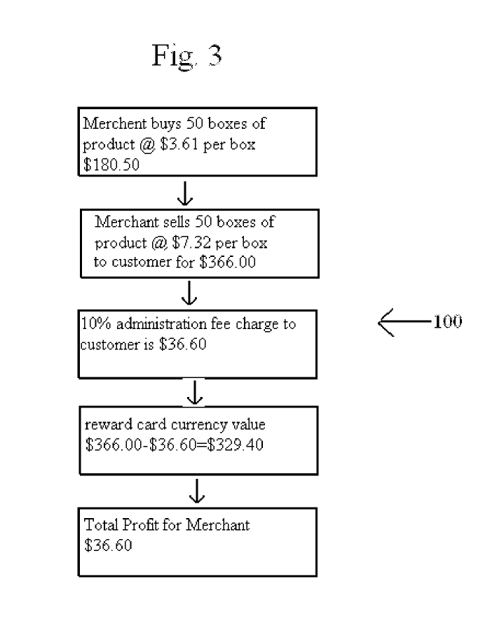

One embodiment of the customer incentive reward card matching method 100 is seen in FIGS. 1-3. The customer incentive reward card matching method 100 allows at least one merchant 130 to create incentive, retention, and marketing methods for at least one customer 140 by providing the customer 140 with at least one reward card 150 that has a matching value to the customer's 140 initial purchase price. The reward card 150 is designed to incentivize the customer 140 to return to the merchant 130 for future transactions. The customer incentive reward card matching method 100 further utilizes at least one point of sale device 110 to download, view, analyze, edit, and process a plurality of customer transaction history data 170.

The customer incentive reward card matching method 100 comprises a first step 200 of displaying the customer transaction history data 170 on the point of sale device 110. The point of sale device 110 processes the customer transaction history data 170 with a computer program 125 that receives instructions from a remote computer 120 such as a server or database. Further, the point of sale device 110 may be used in any type of client/server network environment. A second step 210 comprises charging the customer 140 a premium price for an initial purchase of at least one product or service 160. In this step, the merchant 130 also requires a minimum initial purchase price prior to allowing the customer 140 to participate in the customer incentive reward card matching method 100. The minimum initial purchase requirement incentivizes the customer 140 to purchase products and services 160 in larger volume, which in turn increases profits for the merchant 130. In one embodiment, the minimum purchase price is twenty five dollars. After the customer 140 makes the initial purchase, the third step 220 allows the merchant 130 to charge the customer 140 an administration fee 155. In one embodiment, the administration fee 155 comprises ten percent of the initial purchase price. The administration 155 fee generates a significant percentage of the profits for the merchant 130. In the fourth step 230, the merchant 130 provides the customer 140 with the reward card 150. The reward card 150 has a reward card currency value that matches the initial purchase price minus the administration fee 155. The reward card 150 is what incentivizes the customer 140 to return to the merchant 130 for future transactions. Nonetheless, the fifth step 240 allows the merchant 130 to require at least one prerequisite condition prior to providing the customer 140 with the reward card 150. Some of the requirements can include: the reward card 150 is valid toward transactions only with the merchant or affiliation of merchants, the reward card 150 has no warranties, the reward card 150 is not a credit or debit card, the reward card 150 is not redeemable for cash unless required by law, resale of the reward card 150 is prohibited, the reward card currency value cannot be applied to any credit or loan balance, and the merchant 130 will not replace lost, stolen, or damaged reward cards 150. After receiving the reward card 150, the customer 140 proceeds to the sixth step 250 by making at least one subsequent transaction with the reward card 150 at a future time, the subsequent transaction having a subsequent transaction currency value. The point of sale device 110 automatically deducts the subsequent transaction currency value from the reward card currency value and processes this information to generate additional customer transaction history data 170. The seventh step 260 verifies if the subsequent transaction currency value exceeds the reward card currency value. If it does, the eighth step 270 requires the customer 140 to pay the merchant 130 with additional currency. With the processing capabilities of the point of sale device 110, the ninth step 280 allows the merchant 130 to analyze the customer transaction history data 170. The point of sale device 110 has a computer program 125 with instructions transferred from a remote computer 120, such as a server or database. These instructions allow the point of sale device 110 to generate customer transaction history data 170 based on initial purchases, number of visits, reward card 150 value, reward card 150 usage, seasonal purchases, and other pertinent transaction habits. The merchant 130 is able to view and manipulate all of the customer transaction history data 170 on the point of sale device 110. The merchant 130 can then utilize the information obtained from the customer transaction history data 170 to create additional customer incentive programs and marketing schemes. Additionally, the merchant 130 can allow the customer 140 to view a predetermined amount of the customer transaction history data 170, such as reward card 150 balances, on a network such as the internet from a computer or mobile communication device.

In an embodiment of the present invention, the merchant 130 comprises an affiliation of merchants.

In a further embodiment of the present invention, the customer 140 comprises a business.

In a further embodiment of the present invention, the administrative fee 155 is greater than ten percent of the initial purchase price.

In yet another embodiment of the present invention, the point of sale device 110 can display customer transaction history data 170 on a mobile communication device.

In yet another embodiment of the present invention, the reward card 150 is digitally stored on the customer's 140 mobile communication device, whereby the merchant 130 can digitally send the reward card 150 to the customer.

Although the present invention has been described in considerable detail in reference to preferred versions, other versions are possible. Therefore, the spirit and scope of the appended claims should not be limited to the description of the preferred versions contained herein.

What is claimed is:

1. A customer incentive reward card matching method for allowing at least one merchant to create incentive for at least one customer to repeat business with the merchant while simultaneously generating profits for the merchant, the customer incentive reward card matching method comprising:
a first step of displaying a plurality of customer transaction history data on at least one point of sale device, the point of sale device processing the customer transaction history data with a computer program, the computer program receiving instructions from a remote computer;
a second step of charging the customer a premium price for an initial purchase of at least one product or service, the second step further comprising requiring a minimum initial purchase price prior to allowing the customer to participate in the customer incentive reward card matching method;
a third step of charging the customer an administration fee, the administration fee comprising a predetermined percentage of the initial purchase price;
a fourth step of providing the customer with at least one reward card, the reward card having a reward card currency value equal to the initial purchase price minus the administration fee;
a fifth step of allowing the merchant to require at least one prerequisite condition prior to providing the customer with the reward card;
a sixth step of allowing the customer to make at least one subsequent transaction with the reward card at a future time, the subsequent transaction having a subsequent transaction currency value;
a seventh step of verifying if the subsequent transaction currency value exceeds the reward card currency value for deducting the subsequent transaction currency value from the reward card currency value, whereby a deduction is processed by the point of sale device;
an eighth step of requiring the customer to pay with additional currency if the subsequent transaction currency value is greater than the reward card currency value; and
a ninth step of analyzing each customer transaction history data on the point of sale device for creating additional customer incentive.

2. The customer incentive reward card matching method of claim 1, wherein the merchant is an affiliation of merchants.

3. The customer incentive reward card matching method of claim 1, wherein the customer is a business.

4. The customer incentive reward card matching method of claim 1, wherein the administrative fee is greater than ten percent of the initial purchase price.

5. The customer incentive reward card matching method of claim 1, wherein the point of sale device can display customer transaction history data on a mobile communication device.

6. The customer incentive reward card matching method of claim 1, wherein the reward card is digitally stored on the customer's mobile communication device, whereby the merchant can digitally send the reward card to the customer.
